(19) United States
(12) Patent Application Publication
(10) Pub. No.: US 2022/0382991 A1
(43) Pub. Date: Dec. 1, 2022

(54) TRAINING METHOD AND APPARATUS FOR DOCUMENT PROCESSING MODEL, DEVICE, STORAGE MEDIUM AND PROGRAM

(71) Applicant: Beijing Baidu Netcom Science Technology Co., Ltd., Beijing (CN)

(72) Inventors: Qiming PENG, Beijing (CN); Bin LUO, Beijing (CN); Yuhui CAO, Beijing (CN); Shikun FENG, Beijing (CN); Yongfeng CHEN, Beijing (CN)

(21) Appl. No.: 17/883,908

(22) Filed: Aug. 9, 2022

(30) Foreign Application Priority Data
Mar. 10, 2022 (CN) 202210236324X

(51) Int. Cl. G06F 40/30; G06V 30/414; G06V 30/14

(52) U.S. Cl. CPC G06F 40/30; G06V 30/414; G06V 30/1444

(57) ABSTRACT

The present disclosure provides a training method and apparatus for a document processing model, a device, a storage medium and a program, which relate to the field of artificial intelligence, and in particular, to technologies such as deep learning, natural language processing and text recognition. The specific implementation is: acquiring a first sample document; determining element features of a plurality of document elements in the first sample document and positions corresponding to M position types of each document element according to the first sample document; where the document element corresponds to a character or a document area in the first sample document; and performing training on a basic model according to the element features of the plurality of document elements and the positions corresponding to the M position types of each document element to obtain the document processing model.

### CROSS-REFERENCE TO RELATED APPLICATIONS

This application claims priority to Chinese Patent Application No. 202210236324.X, filed on Mar. 10, 2022, which is hereby incorporated by reference in its entirety.

### TECHNICAL FIELD

The present disclosure relates to technologies such as deep learning, natural language processing, text recognition in the field of artificial intelligence, and in particular, to a training method and apparatus for a document processing model, a device, a storage medium and a program.

### BACKGROUND

Artificial intelligence is a subject that studies how to make a computer to simulate certain thinking procedures and intelligent behaviors of people (such as learning, reasoning, thinking, planning, etc.), which is related to both hardware-level technique and software-level technique. Artificial intelligence hardware technique generally includes technologies such as a sensor, a special-purpose artificial intelligence chip, cloud computing, a cloud distributed storage, big data processing, etc.; and artificial intelligence software technique mainly includes computer vision technique, speech recognition technique, natural language processing technique, machine learning/deep learning, big data processing technique, knowledge mapping technique and other major directions.

Artificial intelligence has been widely used in document processing scenarios. For example, documents can be analyzed, information extracted, or classified by the target model obtained by pre-training. A training procedure of the above target model usually includes two stages: pre-training and fine-tuning training. Specifically, a sample document is used to pre-train a basic model first, so as to obtain a pre-training model which can be used to represent a document semantically. After the pre-training, aiming at a specific document processing task, a small amount of sample data is used to perform fine-tuning training on the pre-training model, so as to obtain a target model corresponding to the specific document processing task.

Generally, in the above pre-training stage, character information in the sample document can be recognized first, and the basic model can be trained by using these pieces of character information to obtain the pre-training model. However, in practical applications, it is found that the accuracy of the above pre-trained model for representing a document semantically is not high.

### SUMMARY

According to a first aspect of the present disclosure, there is provided a training method for a document processing model, including:

acquiring a first sample document;

determining element features of a plurality of document elements in the first sample document and positions corresponding to M position types of each document element according to the first sample document; where the document element corresponds to a character or a document area in the first sample document, and M is an integer greater than or equal to 1; and

performing training on a basic model according to the element features of the plurality of document elements and the positions corresponding to the M position types of each document element to obtain the document processing model.

According to a second aspect of the present disclosure, there is provided a training apparatus for a document processing model, including:

at least one processor; and

a memory connected with the at least one processor in a communication way; where,

the memory stores instructions executable by the at least one processor which, when executed by the at least one processor, enable the at least one processor to:

acquire a first sample document;

determine element features of a plurality of document elements in the first sample document and positions corresponding to M position types of each document element according to the first sample document; wherein the document element corresponds to a character or a document area in the first sample document, and M is an integer greater than or equal to 1; and

perform training on a basic model according to the element features of the plurality of document elements and the positions corresponding to the M position types of each document element to obtain the document processing model.

According to a third aspect of the present disclosure, there is provided a non-transitory computer-readable storage medium storing computer instructions, where the computer instructions are used to cause a computer to:

acquire a first sample document;

determine element features of a plurality of document elements in the first sample document and positions corresponding to M position types of each document element according to the first sample document; wherein the document element corresponds to a character or a document area in the first sample document, and M is an integer greater than or equal to 1; and

perform training on a basic model according to the element features of the plurality of document elements and the positions corresponding to the M position types of each document element to obtain the document processing model.

### BRIEF DESCRIPTION OF THE DRAWINGS

The drawings are used for a better understanding of the present solution and do not constitute a limitation of the present disclosure. Among which:

FIG. 1 is a schematic diagram of an application scenario provided by an embodiment of the present disclosure;

FIG. 2 is a schematic flowchart of a training method for a document processing model provided by an embodiment of the present disclosure;

FIG. 3A is a schematic diagram of a document element provided by an embodiment of the present disclosure;

FIG. 3B is a schematic diagram of another document element provided by an embodiment of the present disclosure;

FIG. 4 is a schematic diagram of a processing procedure of a sample document provided by an embodiment of the present disclosure;

FIG. 5A and FIG. 5B are schematic diagrams of another processing procedure of a sample document provided by an embodiment of the present disclosure;

FIG. 6 is a schematic flowchart of yet another training method for a document processing model provided by an embodiment of the present disclosure;

FIG. 7 is a schematic diagram of a data processing procedure of a basic model provided by an embodiment of the present disclosure;

FIG. 8 is a schematic diagram of a model training procedure provided by an embodiment of the present disclosure;

FIG. 9 is a schematic structural diagram of a training apparatus for a document processing model provided by an embodiment of the present disclosure; and

FIG. 10 is a schematic structural diagram of an electronic device provided by an embodiment of the present disclosure.

### DESCRIPTION OF EMBODIMENTS

Exemplary embodiments of the present disclosure are described below with reference to the drawings, where various details of the embodiments of the present disclosure are included to facilitate understanding, which should be considered as merely exemplary. Therefore, those of ordinary skill in the art should recognize that various changes and modifications can be made to the embodiments described herein without departing from the scope and spirit of the present disclosure. Also, for clarity and conciseness, descriptions of well-known functions and structures are omitted in the following description.

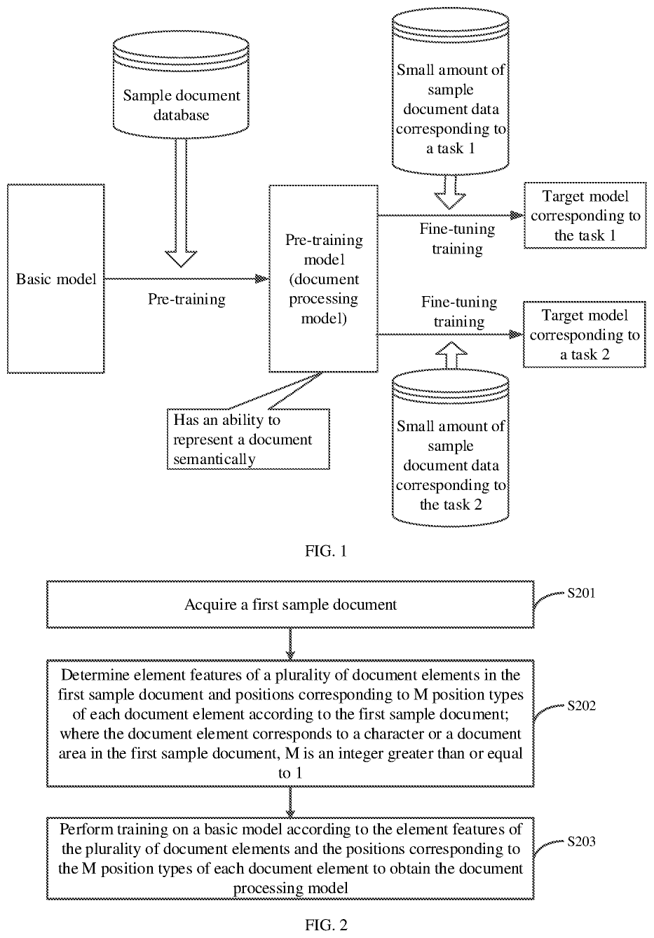

In order to facilitate the understanding of technical solutions provided by the present disclosure, an application scenario of the present disclosure is illustrated with reference to FIG. 1.

FIG. 1 is a schematic diagram of an application scenario provided by an embodiment of the present disclosure. FIG. 1 illustrates a model training procedure of a document processing scenario. Referring to FIG. 1, the model training procedure includes two stages, i.e., a pre-training stage and a fine-tuning training stage, respectively. It should be noted that the above two stages can be performed by a same training device or can be performed by different training devices. The training device can be an electronic device with certain computing capabilities, including but not limited to: a terminal device, a server, etc.

Referring to FIG. 1, in the pre-training stage, sample documents in a sample document database are used to pre-train a basic model to obtain a pre-training model. The pre-training model has an ability to represent a document semantically. The above pre-training procedure usually has nothing to do with a specific document processing task, but mainly makes the pre-training model learn the ability to represent a document semantically.

Continue to refer to FIG. 1, in the fine-tuning training stage, aiming at a specific document processing task, a small amount of sample document data corresponding to the task can be used to perform fine-tuning training on the pre-training model to obtain a target model corresponding to the task. For example, a small amount of sample document data corresponding to a task 1 is used to perform fine-tuning training on the pre-training model to obtain a target model corresponding to the task 1; and a small amount of sample document data corresponding to a task 2 is used to perform fine-tuning training on the pre-training model to obtain a target model corresponding to the task 2. That is, in the fine-tuning training stage, the specific document processing task is targeted for training, so that the target model obtained by training has the ability to complete the document processing task. The above document processing task includes but is not limited to: a document classification task, a document analysis task, an information extraction task from documents, etc.

Generally, in the above pre-training stage, character information in the sample document can be recognized first, and the basic model can be trained by using these pieces of character information to obtain a pre-training model. However, in practical applications, it is found that the accuracy of the above pre-trained model for representing a document semantically is not high.

The present disclosure provides a training method and apparatus for a document processing model, a device, a storage medium and a program, which are applied to technologies such as deep learning, natural language processing and text recognition in the field of artificial intelligence, and can be used in the model pre-training stage to improve the accuracy of the pre-training model for representing a document semantically.

In the technical solutions provided by the present disclosure, the pre-training procedure is as follows: acquiring a first sample document; determining element features of a plurality of document elements in the first sample document and positions corresponding to M position types of each document element according to the first sample document; where the document element corresponds to a character or a document area in the first sample document, and M is an integer greater than or equal to 1; performing training on a basic model according to the element features of the above plurality of document elements and the positions corresponding to the M position types of each document element to obtain a pre-training model.

In the above procedure of pre-training the basic model, it not only utilizes the element features of a plurality of document elements, but also utilizes the positions corresponding to the M position types of each document element, which is equivalent to considering the relationship among all document elements, i.e., the considered information is more comprehensive, thus the accuracy of the pre-training model for representing a document semantically can be improved. In addition, each of the above-mentioned document elements can correspond to a character or a document area in the first sample document, i.e., the present disclosure can analyze a document not only from a character dimension, but also from a document area dimension. Therefore, the accuracy of the pre-training model for representing a document semantically can be further improved.

The technical solutions provided by the present disclosure will be described in detail with reference to the following specific embodiments. The following embodiments can be combined with each other. The same or similar concept or procedure may not be described in detail in some embodiments.

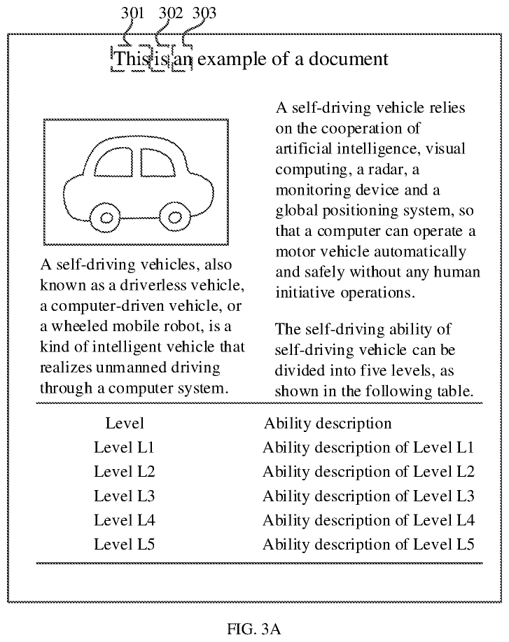

FIG. 2 is a schematic flowchart of a training method for a document processing model provided by an embodiment of the present disclosure. The method of this embodiment can be applied to the pre-training stage in FIG. 1. As shown in FIG. 2, the method of this embodiment includes the following.

S201: acquire a first sample document.

Illustratively, the first sample document can be a sample document in a sample document database in FIG. 1. The first document can be, but not limited to, any of the following document types: .doc, .excel, .ppt, .pdf, .md, .html, .txt, .jpg, .png, etc.

In the embodiments of the present disclosure, the first sample document may include at least one of the following contents: a character, a picture, a table, etc., where the character can be a Chinese character, an English character, or a character of any other languages.

S202: determine element features of a plurality of document elements in the first sample document and positions corresponding to M position types of each document element according to the first sample document; where the document element corresponds to a character or a document area in the first sample document, and M is an integer greater than or equal to 1.

Among which, the document element refers to an object that constitutes the first sample document. A document element can correspond to a character or a document area in the first sample document.

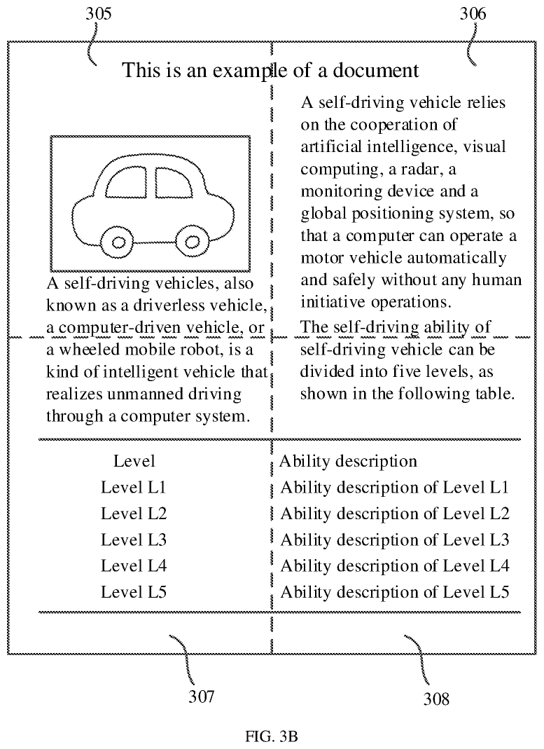

As an example, FIG. 3A is a schematic diagram of a document element provided by an embodiment of the present disclosure. As shown in FIG. 3A, each character in the first sample document (e.g., a character 301, a character 302, a character 303, etc.) can be used as a document element.

As an example, FIG. 3B is a schematic diagram of another document element provided by an embodiment of the present disclosure. As shown in FIG. 3B, the first sample document is divided into four document areas, i.e., a document area 305a document area 306, a document area 307 and a document area 308, respectively. Each of the above document areas can be used as a document element. It should be understood that the embodiments of the present disclosure do not limit the way of dividing the document areas and the number of divided document areas, and FIG. 3B is only an example.

In the embodiments of the present disclosure, each character and each document area in the first sample document can be taken as a document element. That is, assuming that the first sample document includes K1 characters and the first sample document is divided into K2 document areas, K1 characters and K2 document areas in the first sample document are all taken as document elements. In this way, K1+K2 document elements can be determined in the first sample document.

Element features of each document element are used to describe semantic information of the document element. Illustratively, after a plurality of document elements in the first document is determined, each document element can be semantically represented to determine element features of the document element.

Generally, upon describing a position of a document element, it can be described in a number of ways. Illustratively, in a possible way, an identifier (index or ID) of each document element can be adopted to describe a position of a document element. With reference to FIG. 3A, a position of a document element 301 is 1, a position of a document element 302 is 2, and a position of a document element 303 is 3, and so on. In another possible way, coordinate information (x, y, h, w) can be adopted to describe a position of a document element, where (x, y) represents a coordinate of an upper left corner vertex of the document element, h represents a height of the document element, and w represents a width of the document element.

In the embodiments of the present disclosure, it is considered that the semantic of a document is not only related to each document element in the document, but also related to the position among various document elements. Therefore, in order to represent a document semantically better, after a plurality of document elements in the first sample document is determined, the position of each document element can also be determined.

In an implementation, the position of each document element can be a relative position of each document element relative to a certain reference object. Illustratively, the first document element in the first sample document can be used as a reference object, and a relative position of each document element relative to the first document element can be determined respectively.

Further, in the embodiments of the present disclosure, when the position of the document element is determined, the positions corresponding to M position types can be determined. That is, M position types are adopted to represent the positions of the document elements, respectively. In an implementation, the M position types include one or more of the following: a one-dimensional position type, a document width direction position type, and a document height direction position type.

Among which, a position corresponding to the one-dimensional position type of the document element is for indicating an arrangement position of the document element among the plurality of document elements.

For example, taking FIG. 3A as an example for illustration, the position corresponding to the one-dimensional position type of the document element 301 can be represented as 0, the position corresponding to the one-dimensional position type of the document element 302 can be represented as 1, and the position corresponding to the one-dimensional position type of the document element 303 can be represented as 2.

A position corresponding to the document width direction position type of the document element is for indicating an offset between a coordinate of the document element in a document width direction and a first preset reference coordinate, where the first preset reference coordinate can be a coordinate of a preset reference object in the document width direction.

A position corresponding to the document height position type of the document element is for indicating an offset between a coordinate of the document element in a document height direction and a second preset reference coordinate, where the second preset reference coordinate can be a coordinate of the preset reference object in the document height direction.

For example, assuming that coordinate information of the document element 301 is (x1, y1, h, w), coordinate information of the document element 302 is (x2, y2, h, w), and coordinate information of the document element 303 is (x3, y3, h, w). Taking the document element 301 as the preset reference object, then:

for a position type in the document height direction,

the position of the document element 301 can be represented as 0 (y1−y1=0);

the position of the document element 302 can be represented as y2−y1;

the position of the document element 303 can be represented as y3−y1;

for a position type in the document width direction,

the position of the document element 301 can be represented as 0 (x1−x1=0);

the position of the document element 302 can be represented as x2−x1;

the position of the document element 303 can be represented as x3−x1.

In some possible implementations, positions corresponding to various position types of document elements can be converted into vector forms by using a preset look-up table method.

S203: perform training on a basic model according to the element features of the plurality of document elements and the positions corresponding to the M position types of each document element to obtain the document processing model.

Among which, the basic model refers to a to-be-trained model, or an empty model. It should be noted that this embodiment does not limit a network structure of the basic model. Illustratively, the basic model can be a Transformer model.

In this embodiment, training on the basic model can be performed according to the element feature of a plurality of document elements and the positions corresponding to M position types of each document element, so that the basic model can continuously learn and obtain the relationship among the document semantics, the element feature of each document element and the positions of each document element. That is, the basic model has the ability to represent a document semantically through training.

It should be understood that the embodiment shown in FIG. 2 describes a procedure of performing training on the basic model with a sample document. In practical applications, the sample document database includes a plurality of sample documents, and the training procedure of this embodiment is performed for each sample document, respectively, so that the ability of the basic model to represent a document semantically is continuously enhanced. That is, the embodiment shown in FIG. 2 needs to be executed repeatedly, and when the basic model reaches a preset convergence condition, the basic model that reaches the convergence condition is used as a document processing model. The document processing model can also be called a pre-training model.

The training method for a document processing model provided by this embodiment includes: acquiring a first sample document; determining element features of a plurality of document elements in the first sample document and positions corresponding to M position types of each document element according to the first sample document; where the document element corresponds to a character or a document area in the first sample document; and performing training on a basic model according to the element features of the plurality of document elements and the positions corresponding to the M position types of each document element to obtain the document processing model. In the above procedure, not only the element feature of a plurality of document elements, but also the positions corresponding to the M position types of each document element, are utilized, which is equivalent to considering the relationship among all document elements, i.e., the information considered is more comprehensive, so the accuracy of the document processing model for representing a document semantically can be improved.

On the basis of the embodiment shown in FIG. 2, how to process the first sample document to determine the element feature of the plurality of document elements and the positions corresponding to M position types of each document element will be explained with a specific embodiment.

In this embodiment, the plurality of document elements include K1 characters and K2 document areas, and both K1 and K2 are integers greater than or equal to 0. The first sample document can be processed as follows.

(1) character recognition processing is performed on the first sample document to obtain element features of the K1 characters and positions corresponding to M position types of each character.

Illustratively, optical character recognition (OCR) technique can be used to perform character recognition processing on the first sample document to obtain the characters included in the first sample document and the position of each character in the first sample document, where the above position can be represented by a one-dimensional position or a two-dimensional position (for example, coordinate information (x, y, h, w)).

For each character, a word vector corresponding to the character is obtained by performing vector mapping on the character. Position information of each character recognized by the above OCR technique is usually an absolute position. By performing vector mapping on the absolute position of the character, a position vector corresponding to the character can be obtained. According to the word vector and the position vector corresponding to the character, the element feature of the character is generated.

Further, for each position type, a relative position of the character relative to the preset reference object can also be determined according to the absolute position of the character. Thereby, the positions corresponding to the M position types of the character are obtained.

In some possible scenarios, all characters in a document are not arranged in the order from left to right and from top to bottom due to the reasons such as document typesetting and layout. For example, in the document shown in FIG. 3A, the upper part of the document is divided into two columns. Upon reading, the left column is read first, and then the right column is read, and each column is read from left to right and from top to bottom. If the document is directly processed by character recognition, the recognized character sequence will be inconsistent with the reading sequence, which will affect the subsequent model training procedure.

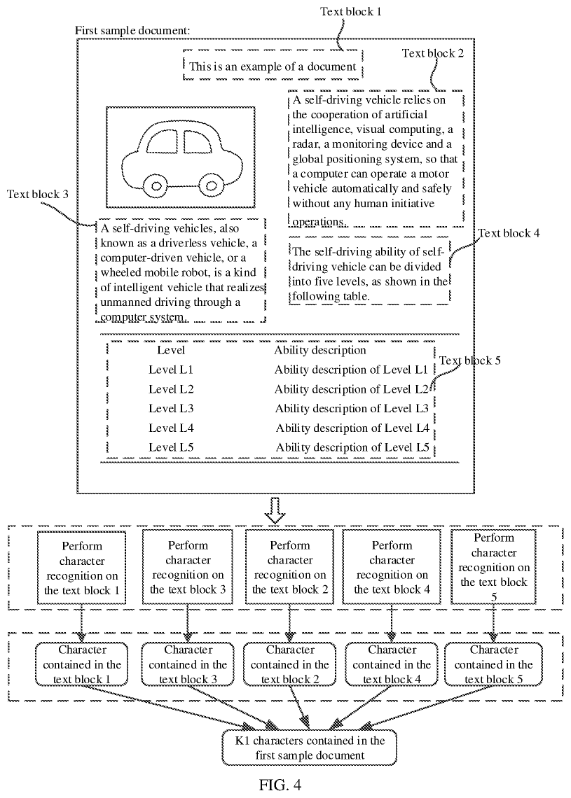

For the above scenario, the document layout can be parsed first to obtain layout information, and then character recognition processing is performed based on the layout information, so as to ensure that the recognized character sequence is consistent with the reading sequence. The following is an example with reference to FIG. 4.

FIG. 4 is a schematic diagram of a processing procedure of a sample document provided by an embodiment of the present disclosure. As shown in FIG. 4, the first sample document can be divided into a plurality of text blocks, and the reading sequence of the plurality of text blocks can be determined. For example, in FIG. 4, the first sample document is divided into five text blocks, whose reading sequence is as follows: a text block 1, a text block 3, a text block 2, a text block 4 and a text block 5.

Continue to refer to FIG. 4, character recognition processing is performed on each text block respectively to obtain the characters contained in the text block and the position information of each character in the text block. According to the reading sequence of the plurality of text blocks, the characters contained in each text block are combined to obtain K1 characters contained in the first sample document. For example, the characters included in the text block 1, the text block 3, the text block 2, the text block 4, and the text block 5 are combined in turn to obtain K1 characters included in the first sample document.

For each character in the K1 characters, a word vector corresponding to the character is obtained by performing vector mapping on the character. According to the position of the character in the text block and the positional relationship among each text block, the absolute position of the character in the first sample document is determined. By performing vector mapping on the absolute position of the character in the first sample document, the position vector corresponding to the character is obtained. According to the word vector and the position vector corresponding to the character, the element feature of the character is generated.

Further, for each position type, the relative position of the character relative to the preset reference object can also be determined according to the absolute position of the character in the first sample document. Thereby, the positions corresponding to the M position types of the character are obtained.

(2) the document image corresponding to the first sample document is divided into K2 document areas, and feature extraction is performed on the document image to obtain element features of the K2 document areas and positions corresponding to M position types of each document area.

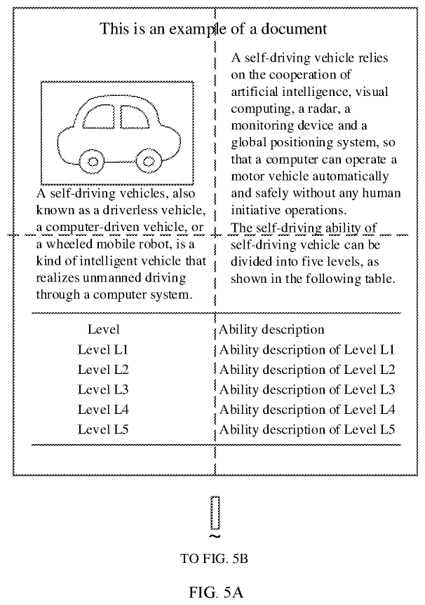

The following is an example with reference to FIG. 5A and FIG. 5B.

FIG. 5A and FIG. 5B schematic diagrams of another processing procedure of a sample document provided by an embodiment of the present disclosure. As shown in FIG. 5A and FIG. 5B, the document image corresponding to the first sample document is divided into K2 document areas (taking K2=4 as an example), and the position of each document area in the document image is determined. The above position can be represented by a one-dimensional position or a two-dimensional position (for example, coordinate information (x, y, h, w)). It should be understood that the above position is an absolute position. Further, for each position type, the relative position of the document area relative to the preset reference object is determined according to the absolute position of each document area. Thereby, the positions corresponding to M position types of each document area are obtained.

Further, feature extraction can be performed on the document image to obtain an image feature of the document image. For example, a document image can be input into a visual encoder with a convolution network structure, and the visual encoder encodes the document image to obtain the image feature. For each document area in K2 document areas, the area feature corresponding to the document area is obtained from the image feature. For example, the image feature is input into an average pooling layer and a full connection layer to map the image feature into the area features of K2 document areas. For each document area, the absolute position of the document area in the document image is processed by vector mapping to obtain a position feature of the document area. The area feature and the position feature of the document area are spliced to obtain the element feature of the document area.

It should be understood that through the above procedure shown in FIG. 4, the element features of K1 characters and the positions corresponding to M position types of each character can be obtained; through the above procedure shown in FIG. 5A and FIG. 5B, the element features of K2 document areas and the positions corresponding to M position types of each document area can be obtained. Taking the above K1 characters and K2 document areas as document elements respectively, the element features of K1+K2 document elements and the positions corresponding to M position types of each document element are obtained. In this way, when the first sample document is used to perform training on the basic model, the document can be analyzed not only from the character dimension, but also from the document area dimension. Therefore, the accuracy of the document processing model for representing a document semantically can be further improved.

On the basis of any of the above embodiments, the training method for a document processing model provided by the present disclosure will be described in more detail with reference to a specific embodiment.

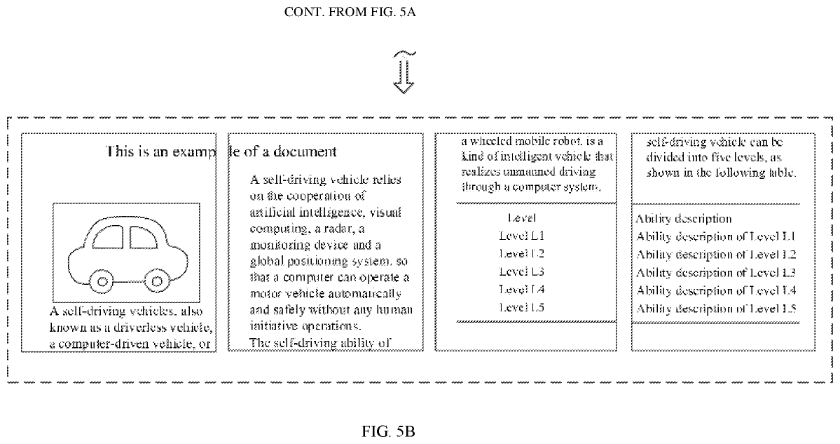

FIG. 6 is a schematic flowchart of yet another training method for a document processing model provided by an embodiment of the present disclosure. The method of this embodiment can be used as a possible implementation of S203 in the example shown in FIG. 2. As shown in FIG. 6, the method of this embodiment includes the following.

S601: input element features of a plurality of document elements and the positions corresponding to the M position types of each document element into the basic model.

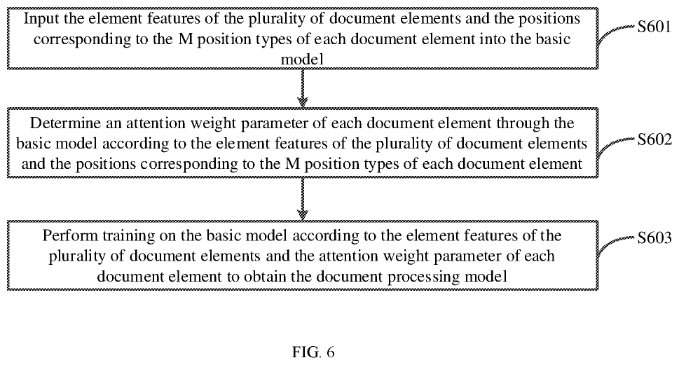

For ease of understanding, the following is an example with reference to FIG. 7.

FIG. 7 is a schematic diagram of a data processing procedure of a basic model provided by an embodiment of the present disclosure. As shown in FIG. 7, assuming that M=3, the M position types are: a position type A, a position type B and a position type C, respectively. For example, the position type A can be a one-dimensional position type, the position type B can be a document height direction position type, and the position type C can be a document width direction position type.

Referring to FIG. 7, it is assumed that the number of document elements is x. The element feature of each document element (document elements 1 to x), a position corresponding to the position type A of each document element (document elements 1 to x), a position corresponding to the position type B of each document element (document elements 1 to x) and a position corresponding to the position type C of each document element (document elements 1 to x) are all input into the basic model.

In this embodiment, the positions corresponding to M position types of each document element are respectively input into the basic model, instead of fusing the positions corresponding to the M position types and then inputting the fused positions into the basic model. In this way, premature fusion of positions corresponding to different position types can be avoided, so that the positions corresponding to different position types can be distinguished within the basic model, or the positions corresponding to different position types can be decoupled within the basic model, so that more knowledge can be learned in the model training procedure, thus the ability to represent a document semantically is improved.

S602: determine an attention weight parameter of each document element through the basic model according to the element features of the plurality of document elements and the positions corresponding to the M position types of each document element.

In other words, within the basic model, an attention weight parameter of each document element is determined according to the element features of the plurality of document elements and the positions corresponding to the M position types of each document element. It should be understood that the greater the attention weight of a document element, the more attention will be applied to the element feature of the document element in the training procedure; and the smaller the attention weight of the document element, the less attention will be applied to the element feature of the document element in the training procedure. It is thus evident that the attention weight parameter of each document element can guide the model training procedure.

In a possible implementation, the attention weight parameter of each document element can be determined as follows.

(1) first linear processing and second linear processing is performed on the element features of the plurality of document elements to obtain a first feature matrix and a second feature matrix respectively.

Illustratively, referring to FIG. 7, a first linear process is performed on the element feature of each document element (document elements 1 to x) to obtain a first feature matrix Q_{c}; and second linear processing is performed on the element feature of each document element (document elements 1 to x) to obtain the second feature matrix K_{c}.

(2) the first linear processing and the second linear processing is performed, for each position type of the M position types, on the position of each document element corresponding to the position type to obtain a first position matrix and a second position matrix corresponding to the position type respectively.

Illustratively, referring to FIG. 7, the first linear processing is performed on the position of each document element (document elements 1 to x) corresponding to the position type A to obtain a first position matrix Qₚ corresponding to the position type A; and the second linear processing is performed on the position of each document element (document elements 1 to x) corresponding to the position type A to obtain a second position matrix Kₚ corresponding to the position type A.

Continue to refer to FIG. 7, the first linear processing is performed on the position of each document element (document elements 1 to x) corresponding to the position type B to obtain a first position matrix Qₓ corresponding to the position type B; and the second linear process is performed on the position of each document element (document elements 1 to x) corresponding to the position type B to obtain a second position matrix Kₓ corresponding to the position type B.

Continue to refer to FIG. 7, the first linear processing is performed on the position of each document element (document elements 1 to x) corresponding to the position type C to obtain a first position matrix Q_{y} corresponding to the position type C; and the second linear process is performed on the positions of each document element (document elements 1 to x) corresponding to the position type C to obtain a second position matrix K_{y} corresponding to the position type C.

(3) the attention weight parameter of each document element is determined according to the first feature matrix, the second feature matrix, and the first position matrix and the second position matrix corresponding to each of the M position types.

In a possible implementation, the following manners can be adopted.

(a) a first attention matrix is determined according to the first feature matrix and the second feature matrix.

Illustratively, referring to FIG. 7, a preset operation may be performed on the first feature matrix Q_{c} and the second feature matrix K_{c} to obtain the first attention matrix. In an implementation, the above preset operation can be a matrix point multiplication operation.

(b) a second attention matrix corresponding to the position type is determined according to the first feature matrix and the second position matrix corresponding to each position type.

Continue to refer to FIG. 7, the first feature matrix Q_{c} and the second position matrix Kₚ corresponding to the position type A are performed a preset operation to obtain the second attention matrix corresponding to the position type A; the first feature matrix Q_{c} and the second position matrix Kₓ corresponding to the position type B is performed a preset operation to obtain the second attention matrix corresponding to the position type B; and the first feature matrix Q_{c} and the second position matrix K_{y} corresponding to the position type C is performed a preset operation to obtain the second attention matrix corresponding to the position type C. In an implementation, the above preset operation can be a matrix point multiplication operation.

(c) a third attention matrix corresponding to the position type is determined according to the second feature matrix and the first position matrix corresponding to each position type.

Continue to refer to FIG. 7, the second feature matrix K_{c} and the first position matrix Qₚ corresponding to the position type A is performed a preset operation to obtain the third attention matrix corresponding to the position type A; the second feature matrix K_{c} and the first position matrix Qₓ corresponding to the position type B is performed a preset operation to obtain the third attention matrix corresponding to the position type B; and the second feature matrix K_{c} and the first position matrix Q_{y} corresponding to the position type C is performed a preset operation to obtain the third attention matrix corresponding to the position type C. In an implementation, the above preset operation can be a matrix point multiplication operation.

(d) the attention weight parameter of each document element is determined according to the first attention matrix, and the second attention matrix and the third attention matrix corresponding to each of the M position types.

In an implementation, the sum of the first attention matrix, and the second attention matrix and the third attention matrix corresponding to the M position types, respectively, can be determined as a target attention matrix, and then, according to the target attention matrix, the attention weight parameter of each document element is determined.

Illustratively, referring to FIG. 7, the first attention matrix, the second attention matrix corresponding to the position type A, the third attention matrix corresponding to the position type A, the second attention matrix corresponding to the position type B, the third attention matrix corresponding to the position type B, the second attention matrix corresponding to the position type C and the third attention matrix corresponding to the position type C can be added to obtain a target attention matrix. Furthermore, based on the target attention matrix, the attention weight parameter of each document element is determined.

S603: perform training on the basic model according to the element features of the plurality of document elements and the attention weight parameter of each document element to obtain the document processing model.

Illustratively, continue to refer to FIG. 7, a third linear processing may be performed on the element feature of each document element (document elements 1 to x) to obtain a third feature matrix V. Furthermore, training on the basic model is performed according to the third feature matrix V and the attention weight parameter of each document element to obtain the document processing model.

Since the attention weight parameter of each document element indicates how much attention is applied to each document element in the training procedure, upon training the basic model, different attentions can be applied to different document elements according to the attention weight parameter of each document element, thereby improving the ability of the document processing model for representing a document semantically.

In this embodiment, by inputting the element feature of each document element and the positions corresponding to the M position types of each document element into the basic model, the positions corresponding to different position types can be distinguished within the basic model, or, the positions corresponding to different position types can be decoupled within the basic model, so that more knowledge can be learned in the model training procedure, thus the ability to represent a document semantically is improved.

Further, within the basic model, upon determining the attention weight parameter of each document element, not only the first attention matrix obtained by the first feature matrix Q_{c} and the second feature matrix K_{c} is considered, but also the second attention matrix corresponding to each position type obtained by the first feature matrix Q_{c} and the second position matrix (Kᵣ, Kₓ, K_{y}) corresponding to different position types, and the third attention matrix corresponding to each position type obtained by the second feature matrix K_{c} and the first position matrix (Qₚ, Qₓ, Q_{y}) corresponding to different position types are considered. That is, upon determining the attention weight parameter of each document element, the relationship between the element features and the positions corresponding to different position types is fully considered, so that more knowledge can be learned in the model training procedure, and then the ability to represent a document semantically is improved.

On the basis of the embodiments shown in FIG. 6 and FIG. 7, during the pre-training procedure of the basic model, a manner of simultaneously training N training tasks may be adopted, where N is an integer greater than 1 or equal to 1. In this way, the document processing model can be quickly migrated to different document processing task scenarios.

Taking 4 training tasks as examples to illustrate. Assume the 4 training tasks are as follows.

Training task 1: mask part of the characters in the sample document, and during the pre-training procedure, and predict a masked character. In this prediction task, in addition to masking part of the characters, it is also necessary to smear the document area where the masked character are located, so as to avoid the leakage of a label on the document area side.

Training task 2: randomly smear a document area in the first sample document and then predict which character(s) is/are smeared.

Training task 3: randomly replace a certain document area in the first sample document, and predict which document area is replaced.

Training task 4: for a certain character in the first sample document, predict which character is the next character.

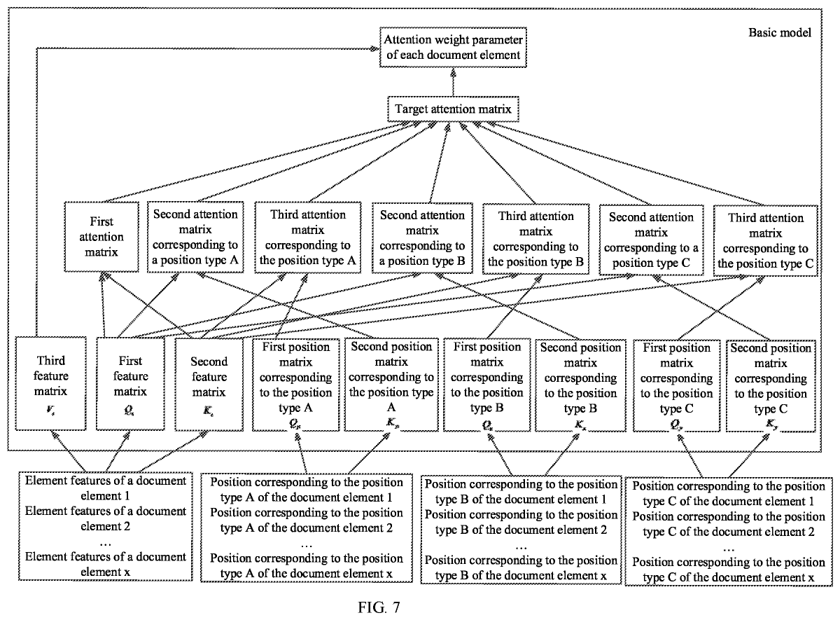

With reference to FIG. 8, the model training mode of executing a plurality of training tasks at the same time will be illustrated. FIG. 8 is a schematic diagram of a model training procedure provided by an embodiment of the present disclosure. As shown in FIG. 8, before inputting the relevant data of the first sample document (the element feature of each document element and the positions corresponding to the M types of positions of each document element) into the basic model, further including: determining a target document element corresponding to each training task in the plurality of document elements respectively, and performing scrambling processing on the target document element. That is, after scrambling processing is performed on the target document elements corresponding to the above four training tasks, which is then input into the basic model. The above scrambling processing can be masking processing, replacing processing, smearing processing, etc.

Within the basic model, a prediction document element corresponding to each training task can be determined according to the third feature matrix and the attention weight parameter of each document element respectively. Taking FIG. 8 as an example for illustration, for the training task 1, according to the third feature matrix and the attention weight parameter of each document element, the prediction document element corresponding to the training task 1 is determined (i.e., which character is predicted to be masked). For the training task 2, according to the third feature matrix and the attention parameter of each document element, the prediction document element corresponding to the training task 2 is determined (i.e., which character is predicted to be smeared). For the training task 3, according to the third feature matrix and the attention parameter of each document element, the prediction document element corresponding to the training task 3 is determined (i.e., which document area is predicted to be replaced). For the training task 4, according to the third feature matrix and the attention parameter of each document element, the prediction document element corresponding to the training task 4 is determined (i.e., the next character is predicted).

Further, training on the basic model can be performed according to the target document element corresponding to each of the N training tasks and the prediction document element corresponding to each of the N training tasks, to obtain the document processing model.

Illustratively, for each training task of the N training tasks, a loss function corresponding to the training task is determined according to a target document element and a prediction document element corresponding to the training task. Taking FIG. 8 as an example for illustration, a loss function corresponding to the training task 1 is determined according to the prediction document element corresponding to the training task 1 and the target document element corresponding to the training task 1; a loss function corresponding to the training task 2 is determined according to the prediction document element corresponding to the training task 2 and the target document element corresponding to the training task 2; a loss function corresponding to the training task 3 is determined according to the prediction document element corresponding to the training task 3 and the target document element corresponding to the training task 3; and a loss function corresponding to the training task 4 is determined according to the prediction document element corresponding to the training task 4 and the target document element corresponding to the training task 4.

A target loss function is determined according to the loss function corresponding to each of the N training tasks. Referring to FIG. 8, the loss functions corresponding to the training task 1, the training task 2, the training task 3 and the training task 4 can be performed preset operations to obtain the target loss functions. Further, a model parameter of the basic model is updated according to the target loss function.

It should be understood that the above description is an iterative training procedure. For a plurality of sample documents, the above iterative training procedure is respectively executed until the training is stopped when the basic model reaches the convergence condition. The basic model that reaches the convergence condition is taken as the document processing model.

In this embodiment, by adopting the model training mode of a plurality of training tasks at the same time, the document processing model integrates the training objections of the plurality of training tasks, improves the effect of the document processing model for representing a document semantically, and enables the document processing model to quickly migrate to different document processing scenarios.

On the basis of any of the above embodiments, after the document processing model is obtained, further including: acquiring sample data corresponding to a preset document task, where the sample data includes a second sample document and annotation data corresponding to the second sample document; performing processing on the second sample document through the document processing model to obtain prediction data; and adjusting a parameter of the document processing model according to a difference between the prediction data and the annotation data to obtain a target model corresponding to the preset document task.

Among which, the above preset document task can be, but is not limited to, any of the following: a document classification task, a document analysis task, an information extraction task from documents, etc.

The sample data includes a second sample document and annotation data corresponding to the second sample document. It should be understood that the annotation data in the sample data may be different for different document processing tasks, which is not limited in this embodiment. For example, for the document classification task, the above annotation data may indicate an annotation category of the second sample document; for the document analysis task, the above annotation data may indicate an annotation analysis result of the second sample document; and for the document information extraction task, the above annotation data may indicate an annotation information extraction result of the second sample document.

The second sample data is input into the document processing model, and the document processing model processes the second sample data to obtain the prediction data. It should be understood that the prediction data output by the document processing model may be different for different document processing tasks, which is not limited in this embodiment. For example, for the document classification task, the above prediction data may indicate a prediction category of the second sample document; for the document analysis task, the above prediction data may indicate a prediction analysis result of the second sample document; and for the document information extraction task, the above prediction data may indicate a prediction information extraction result of the second sample document.

The loss function is determined according to the prediction data and the annotation data, and the model parameter of the document processing model is adjusted according to the loss function.

It should be understood that this embodiment describes the fine-tuning stage shown in FIG. 1. In the fine-tuning stage, it is only needed to perform fine-tuning training on the document processing model obtained in the pre-training stage by using a small amount of sample data corresponding to the preset document task, to obtain the target model corresponding to the preset document task, which improves the model training efficiency. In the present disclosure, the pre-training procedure improves the ability of the document processing model for representing a document semantically. Therefore, the document processing quality of the target model corresponding to the preset document task is also improved.

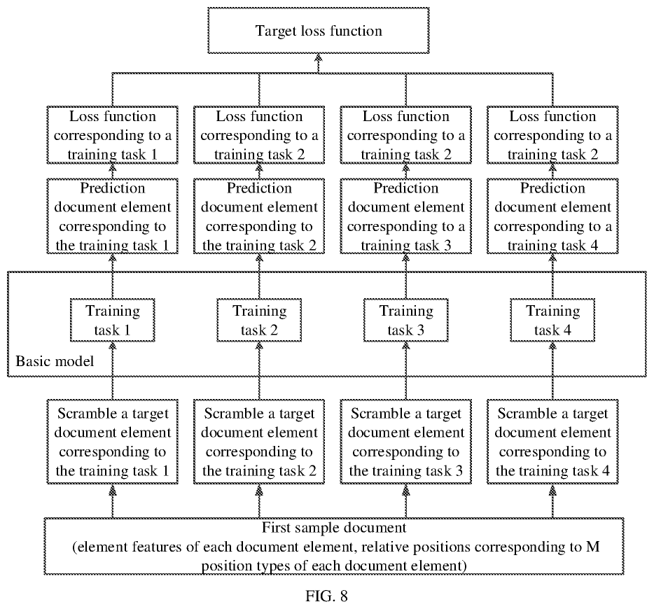

FIG. 9 is a schematic structural diagram of a training apparatus for a document processing model provided by an embodiment of the present disclosure. The training apparatus of the document processing model provided in this embodiment may be in the form of software and/or hardware. As shown in FIG. 9, the training apparatus of the document processing model 900 provided by this embodiment includes a first acquisition module 901, a processing module 902 and a first training module 903, where

the first acquisition module 901 is configured to acquire a first sample document;

a determination module 902 is configured to determine element features of a plurality of document elements in the first sample document and positions corresponding to M position types of each document element according to the first sample document; where the document element corresponds to a character or a document area in the first sample document, and M is an integer greater than or equal to 1; and

the first training module 903 is configured to perform training on a basic model according to the element features of the plurality of document elements and the positions corresponding to the M position types of each document element to obtain the document processing model.

In a possible implementation, the first training module 903 includes:

an input unit, configured to input the element features of the plurality of document elements and the positions corresponding to the M position types of each document element into the basic model;

a first determination unit, configured to determine an attention weight parameter of each document element through the basic model according to the element features of the plurality of document elements and the positions corresponding to the M position types of each document element; and

a training unit, configured to perform training on the basic model according to the element features of the plurality of document elements and the attention weight parameter of each document element to obtain the document processing model.

In a possible implementation, the first determination unit includes:

a first processing subunit, configured to perform first linear processing and second linear processing on the element features of the plurality of document elements to obtain a first feature matrix and a second feature matrix respectively;

a second processing subunit, configured to perform, for each position type of the M position types, the first linear processing and the second linear processing on the position of each document element corresponding to the position type to obtain a first position matrix and a second position matrix corresponding to the position type respectively; and

a determination subunit, configured to determine the attention weight parameter of each document element according to the first feature matrix, the second feature matrix, and the first position matrix and the second position matrix corresponding to each of the M position types.

In a possible implementation, the determination subunit is specifically configured to:

determine a first attention matrix according to the first feature matrix and the second feature matrix;

determine a second attention matrix corresponding to the position type according to the first feature matrix and the second position matrix corresponding to each position type;

determine a third attention matrix corresponding to the position type according to the second feature matrix and the first position matrix corresponding to each position type; and

determine the attention weight parameter of each document element according to the first attention matrix, and the second attention matrix and the third attention matrix corresponding to each of the M position types.

In a possible implementation, the determination subunit is specifically configured to:

determine a sum of the first attention matrix, and the second attention matrix and the third attention matrix corresponding to each of the M position types as a target attention matrix; and

determine the attention weight parameter of each document element according to the target attention matrix.

In a possible implementation, the training unit includes:

a third processing subunit, configured to perform third linear processing on the element features of the plurality of document elements to obtain a third feature matrix; and

a training subunit, configured to perform training on the basic model according to the third feature matrix and the attention weight parameter of each document element to obtain the document processing model.

In a possible implementation, the first training module 903 further includes:

a scrambling processing unit, configured to determine a target document element corresponding to each training task in the plurality of document elements according to N training tasks respectively, and performing scrambling processing on the target document element; N is an integer greater than or equal to 1;

the training subunit is specifically configured to:

determine a prediction document element corresponding to each training task respectively, according to the third feature matrix and the attention weight parameter of each document element; and

perform training on the basic model according to the target document element corresponding to each of the N training tasks and the prediction document element corresponding to each of the N training tasks to obtain the document processing model.

In a possible implementation, the training subunit is specifically configured to:

for each training task of the N training tasks, determine a loss function corresponding to the training task according to the target document element and the prediction document element corresponding to the training task;

determine a target loss function according to the loss function corresponding to each of the N training tasks; and

update, according to the target loss function, a model parameter of the basic model to obtain the document processing model.

In a possible implementation, the plurality of document elements include K1 characters and K2 document areas, and both K1 and K2 are integers greater than or equal to 0; and the determination module 902 includes:

a second determination unit, configured to perform character recognition processing on the first sample document to obtain element features of the K1 characters and positions corresponding to M position types of each character; and

a third determination unit, configured to divide the document image corresponding to the first sample document into K2 document areas, and perform feature extraction on the document image to obtain element features of K2 document areas and positions corresponding to M position types of each document area.

In a possible implementation, the training apparatus of the document processing model 900 of this embodiment further includes:

a second acquisition module, configured to acquire sample data corresponding to a preset document task, where the sample data includes a second sample document and annotation data corresponding to the second sample document;

a processing module, configured to perform processing on the second sample document through the document processing model to obtain prediction data; and

a second training module, configured to adjust a parameter of the document processing model according to a difference between the prediction data and the annotation data to obtain a target model corresponding to the preset document task.

In a possible implementation, the M position types include one or more of the following:

a one-dimensional position type, a document width direction position type, and a document height direction position type;

a position corresponding to the one-dimensional position type of the document element is for indicating an arrangement position of the document element among the plurality of document elements;

a position corresponding to the document width direction position type of the document element is for indicating an offset between a coordinate of the document element in a document width direction and a first preset reference coordinate; and

a position corresponding to the document height position type of the document element is for indicating an offset between a coordinate of the document element in a document height direction and a second preset reference coordinate.

The training apparatus for a document processing model provided by this embodiment can be used to execute the training method for a document processing model provided by any of the above-mentioned method embodiments, and their implementation principles and technical effects are similar, which will not be repeated herein.

In the technical solutions of the present disclosure, collection, storage, usage, processing, transmission, provision and disclosure of the users personal information involved are in compliance with relevant laws and regulations, and do not violate public order and good customs.

According to embodiments of the present disclosure, the present disclosure also provides an electronic device, a readable storage medium and a computer program product.

According to an embodiment of the present disclosure, the present disclosure further provides a computer program product, where the computer program product includes: a computer program stored in a readable storage medium, and at least one processor of the electronic device can read the computer program from the readable storage medium, and at least one processor executes the computer program to cause the electronic device to execute the solution provided in any of the above embodiments.

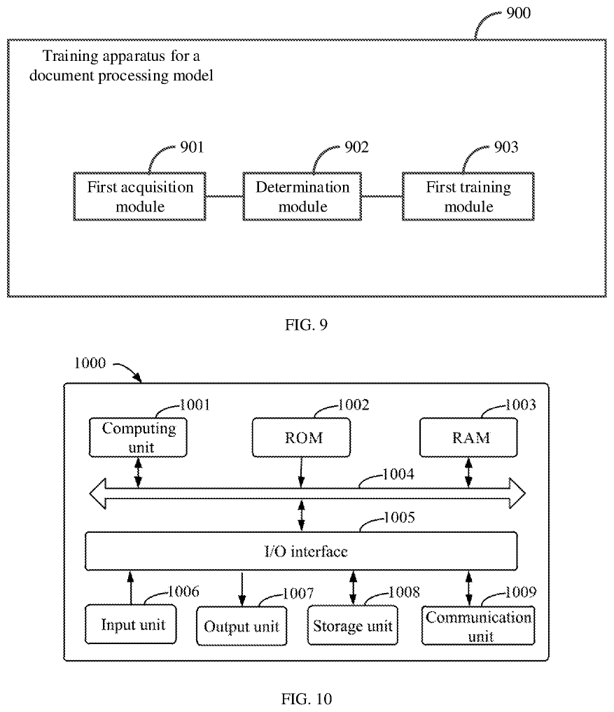

FIG. 10 shows a schematic block diagram of an example electronic device 1000 that can be used to implement the embodiments of the present disclosure. Electronic devices are intended to represent various forms of digital computers, such as laptop computers, desktop computers, workstations, personal digital assistants, servers, blade servers, mainframe computers, and other suitable computers. Electronic devices can also represent various forms of mobile apparatuses, such as personal digital assistants, cellular phones, smart phones, wearable devices, and other similar computing apparatuses. The components shown herein, their connections and relationships, and their functions are merely examples, and are not intended to limit the implementations of the present disclosure described and/or required herein.

As shown in FIG. 10, the electronic device 1000 includes a computing unit 1001, which can perform various appropriate actions and processes based on a computer program stored in a read-only memory (ROM) 1002 or a computer program loaded from a memory unit 1008 into a random access memory (RAM) 1003. In the RAM 1003, various programs and data required for the operation of the electronic device 1000 can also be stored. The computing unit 1001, the ROM 1002, and the RAM 1003 are connected to each other through a bus 1004. An input/output (I/O) interface 1005 is also connected to the bus 1004.

A plurality of components in the electronic device 1000 connected to the I/O interface 1005 include: an input unit 1006, such as a keyboard, a mouse, etc.; an output unit 1007, such as various types of displays and speakers, etc.; and a storage unit 1008, such as a magnetic disk, an optical disk, etc.; and a communication unit 1009, such as a network card, a modem, a wireless communication transceiver, etc. The communication unit 1009 allows the electronic device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, central processing units (CPU), graphics processing units (GPU), various special-purpose artificial intelligence (AI) computing chips, various computing units that run machine learning model algorithms, digital signal processors (DSP), and any appropriate processors, controllers, microcontrollers, etc. The computing unit 1001 executes the various methods and processes described above, for example, a training method for a document processing model. For example, in some embodiments, the training method for a document processing model may be implemented as a computer software program, which is tangibly contained in a machine-readable medium, such as the storage unit 1008. In some embodiments, part or all of the computer program may be loaded and/or installed on the electronic device 1000 via the ROM 1002 and/or the communication unit 1009. When the computer program is loaded into the RAM 1003 and executed by the computing unit 1001, one or more steps of the training method for a document processing model described above can be executed. Alternatively, in other embodiments, the computing unit 1001 may be configured to perform the training method for a document processing model in any other suitable mode (for example, by means of firmware).

Various implementations of the systems and technologies described herein can be implemented in digital electronic circuit systems, integrated circuit systems, field programmable gate arrays (FPGA), application specific integrated circuits (ASIC), application specific standard products (ASSP), system-on-chip (SOC), complex programmable logic devices (CPLD), computer hardware, firmware, software, and/or combinations thereof. These various implementations may include implementing in one or more computer programs that can be executed and/or interpreted on a programmable system including at least one programmable processor, and the programmable processor can be a special purpose or a general purpose programmable processor and can receive data and instructions from and transmit data and instructions to the storage system, at least one input apparatus, and at least one output apparatus.

The program codes used to implement the methods of the present disclosure can be written in any combination of one or more programming languages. These program codes can be provided to the processors or controllers of general-purpose computers, special-purpose computers, or other programmable data processing apparatuses, so that when the program codes, when executed by the processors or controllers, enable the functions/operations specified in the flowcharts and/or block diagrams to be implemented. The program codes can be executed entirely on a machine, partly executed on the machine, partly executed on the machine and partly executed on a remote machine as an independent software package, or entirely executed on the remote machine or a server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, a magnetic, an optical, an electromagnetic, an infrared, or a semiconductor system, apparatus, or device, or any suitable combinations of the above. More specific examples of the machine-readable storage medium might include electrical connections based on one or more wires, portable computer disks, hard disks, random access memories (RAM), read-only memories (ROM), erasable programmable read-only memories (EPROM or flash memory), optical fibers, portable compact disk read-only memories (CD-ROM), optical storage devices, magnetic storage devices, or any suitable combination of the above.

In order to provide interaction with the user, the systems and techniques described herein can be implemented on a computer that has: a display apparatus for displaying information to a user (for example, a CRT (cathode ray tube) or a LCD (liquid-crystal display) monitor); and a keyboard and a pointing apparatus (for example, a mouse or a trackball) through which the user can provide input to the computer. Other types of apparatuses can also be used to provide interaction with the user; for example, the feedback provided to the user can be any form of sensory feedback (for example, visual feedback, auditory feedback, or tactile feedback); and can be in any form (including acoustic input, voice input, or tactile input) to receive input from the user.

The systems and technologies described herein can be implemented in a computing system including background components (e.g., as a data server), a computing system including middleware components (e.g., an application server), or a computing system including front-end components (e.g., a user computer with a graphical user interface or a web browser through which users can interact with implementations of the systems and technologies described herein), or a computing system including any combination of such background components, middleware components, or front-end components. The components of the system can be connected to each other through any form or medium of digital data communication (for example, a communication network). Examples of communication networks include: a local area network (LAN), a wide area network (WAN), and the Internet.

The computer system can include a client and a server. The client and the server are generally remote from each other and usually interact through a communication network. The relationship between the client and the server is generated by computer programs that run on the corresponding computers and have a client-server relationship with each other. The server can be a cloud server (also known as a cloud computing server or a cloud host), which is a host product in a cloud computing service system to solve the defects of difficult management and weak business scalability in traditional physical host and VPS (Virtual Private Server) service. The server can also be a server of a distributed system, or a server combined with a blockchain.

It should be understood that the various forms of processes shown above can be used to reorder, add or delete steps. For example, the steps recited in the present disclosure can be executed in parallel, sequentially or in a different order, which is not limited herein as long as the desired result of the technical solution disclosed in the present disclosure can be achieved.

The above-mentioned detailed implementations do not limit the protection scope of the present disclosure. It should be understood by those skilled in the art that various modifications, combinations, sub-combinations and substitutions can be made according to design requirements and other factors. Any modifications, equivalent replacements, improvements and the like made within the spirit and the principle of the present disclosure shall be included in the protection scope of the present disclosure.

What is claimed is:

1. A training method for a document processing model, comprising:
acquiring a first sample document;
determining element features of a plurality of document elements in the first sample document and positions corresponding to M position types of each document element according to the first sample document; wherein the document element corresponds to a character or a document area in the first sample document, and M is an integer greater than or equal to 1; and
performing training on a basic model according to the element features of the plurality of document elements and the positions corresponding to the M position types of each document element to obtain the document processing model.

2. The method according to claim 1, wherein the performing training on the basic model to obtain the document processing model according to the element features of the plurality of document elements and the positions corresponding to the M position types of each document element comprises:
inputting the element features of the plurality of document elements and the positions corresponding to the M position types of each document element into the basic model;
determining an attention weight parameter of each document element through the basic model according to the element features of the plurality of document elements and the positions corresponding to the M position types of each document element; and
performing training on the basic model according to the element features of the plurality of document elements and the attention weight parameter of each document element to obtain the document processing model.

3. The method according to claim 2, wherein determining the attention weight parameter of each document element according to the element features of the plurality of document elements and the positions corresponding to the M position types of each document element comprises:
performing first linear processing and second linear processing on the element features of the plurality of document elements to obtain a first feature matrix and a second feature matrix respectively;
performing, for each position type of the M position types, the first linear processing and the second linear processing on the position of each document element corresponding to the position type to obtain a first position matrix and a second position matrix corresponding to the position type respectively; and
determining the attention weight parameter of each document element according to the first feature matrix, the second feature matrix, and the first position matrix and the second position matrix corresponding to each of the M position types.

4. The method according to claim 3, wherein the determining the attention weight parameter of each document element according to the first feature matrix, the second feature matrix, and the first position matrix and the second position matrix corresponding to each of the M position types comprises:
determining a first attention matrix according to the first feature matrix and the second feature matrix;
determining a second attention matrix corresponding to the position type according to the first feature matrix and the second position matrix corresponding to each position type;
determining a third attention matrix corresponding to the position type according to the second feature matrix and the first position matrix corresponding to each position type; and
determining the attention weight parameter of each document element according to the first attention matrix, and the second attention matrix and the third attention matrix corresponding to each of the M position types.

5. The method according to claim 4, wherein the determining the attention weight parameter of each document element according to the first attention matrix, and the second attention matrix and the third attention matrix corresponding to each of the M position types comprises:
determining a sum of the first attention matrix, and the second attention matrix and the third attention matrix corresponding to each of the M position types as a target attention matrix; and
determining the attention weight parameter of each document element according to the target attention matrix.

6. The method according to claim 2, wherein the performing training on the basic model according to the element features of the plurality of document elements and the attention weight parameter of each document element, to obtain the document processing model comprises:
performing third linear processing on the element features of the plurality of document elements to obtain a third feature matrix; and
performing training on the basic model according to the third feature matrix and the attention weight parameter of each document element to obtain the document processing model.

7. The method according to claim 3, wherein the performing training on the basic model according to the element features of the plurality of document elements and the attention weight parameter of each document element, to obtain the document processing model comprises:
performing third linear processing on the element features of the plurality of document elements to obtain a third feature matrix; and
performing training on the basic model according to the third feature matrix and the attention weight parameter of each document element to obtain the document processing model.

8. The method according to claim 4, wherein the performing training on the basic model according to the element features of the plurality of document elements and the attention weight parameter of each document element, to obtain the document processing model comprises:
performing third linear processing on the element features of the plurality of document elements to obtain a third feature matrix; and
performing training on the basic model according to the third feature matrix and the attention weight parameter of each document element to obtain the document processing model.

9. The method according to claim 5, wherein the performing training on the basic model according to the element features of the plurality of document elements and the attention weight parameter of each document element, to obtain the document processing model comprises:
performing third linear processing on the element features of the plurality of document elements to obtain a third feature matrix; and
performing training on the basic model according to the third feature matrix and the attention weight parameter of each document element to obtain the document processing model.

10. The method according to claim 6, before inputting the element features of the plurality of document elements and the positions corresponding to the M position types of each document element into the basic model, further comprising:
determining a target document element corresponding to each training task in the plurality of document elements according to N training tasks respectively, and performing scrambling processing on the target document element; N is an integer greater than or equal to 1;
the performing training on the basic model according to the third feature matrix and the attention weight parameter of each document element to obtain the document processing model comprises:
determining a prediction document element corresponding to each training task respectively, according to the third feature matrix and the attention weight parameter of each document element; and
performing training on the basic model according to the target document element corresponding to each of the N training tasks and the prediction document element corresponding to each of the N training tasks to obtain the document processing model.

11. The method according to claim 7, before inputting the element features of the plurality of document elements and the positions corresponding to the M position types of each document element into the basic model, further comprising:
determining a target document element corresponding to each training task in the plurality of document elements according to N training tasks respectively, and performing scrambling processing on the target document element; N is an integer greater than or equal to 1;
the performing training on the basic model according to the third feature matrix and the attention weight parameter of each document element to obtain the document processing model comprises:
determining a prediction document element corresponding to each training task respectively, according to the third feature matrix and the attention weight parameter of each document element; and
performing training on the basic model according to the target document element corresponding to each of the N training tasks and the prediction document element corresponding to each of the N training tasks to obtain the document processing model.

12. The method according to claim 10, wherein the performing training on training the basic model according to the target document element corresponding to each of the N training tasks and the prediction document element corresponding to each of the N training tasks to obtain the document processing model comprises:
for each training task of the N training tasks, determining a loss function corresponding to the training task according to the target document element and the prediction document element corresponding to the training task;
determining a target loss function according to the loss function corresponding to each of the N training tasks; and
updating, according to the target loss function, a model parameter of the basic model to obtain the document processing model.

13. The method according to claim 1, wherein the plurality of document elements comprises K1 characters and K2 document areas, and both K1 and K2 are integers greater than or equal to 0; and the determining element features of a plurality of document elements in the first sample document and the positions corresponding to M position types of each document element according to the first sample document comprises:
performing character recognition processing on the first sample document to obtain element features of the K1 characters and positions corresponding to M position types of each character; and
dividing the document image corresponding to the first sample document into K2 document areas, and performing feature extraction on the document image to obtain element features of K2 document areas and positions corresponding to M position types of each document area.

14. The method according to claim 2, wherein the plurality of document elements comprises K1 characters and K2 document areas, and both K1 and K2 are integers greater than or equal to 0; and the determining element features of a plurality of document elements in the first sample document and the positions corresponding to M position types of each document element according to the first sample document comprises:
performing character recognition processing on the first sample document to obtain element features of the K1 characters and positions corresponding to M position types of each character; and
dividing the document image corresponding to the first sample document into K2 document areas, and performing feature extraction on the document image to obtain element features of K2 document areas and positions corresponding to M position types of each document area.

15. The method according to claim 1, after obtaining the document processing model, further comprising:
acquiring sample data corresponding to a preset document task, wherein the sample data comprises a second sample document and annotation data corresponding to the second sample document;
performing processing on the second sample document through the document processing model to obtain prediction data; and
adjusting a parameter of the document processing model according to a difference between the prediction data and the annotation data to obtain a target model corresponding to the preset document task.

16. The method according to claim 2, after obtaining the document processing model, further comprising:
acquiring sample data corresponding to a preset document task, wherein the sample data comprises a second sample document and annotation data corresponding to the second sample document;
performing processing on the second sample document through the document processing model to obtain prediction data; and
adjusting a parameter of the document processing model according to a difference between the prediction data and the annotation data to obtain a target model corresponding to the preset document task.

17. The method according to claim 1, wherein the M position types comprise one or more of the following:
a one-dimensional position type, a document width direction position type, and a document height direction position type;
a position corresponding to the one-dimensional position type of the document element is for indicating an arrangement position of the document element among the plurality of document elements;
a position corresponding to the document width direction position type of the document element is for indicating an offset between a coordinate of the document element in a document width direction and a first preset reference coordinate; and
a position corresponding to the document height position type of the document element is for indicating an offset between a coordinate of the document element in a document height direction and a second preset reference coordinate.

18. The method according to claim 2, wherein the M position types comprise one or more of the following:
a one-dimensional position type, a document width direction position type, and a document height direction position type;
a position corresponding to the one-dimensional position type of the document element is for indicating an arrangement position of the document element among the plurality of document elements;
a position corresponding to the document width direction position type of the document element is for indicating an offset between a coordinate of the document element in a document width direction and a first preset reference coordinate; and
a position corresponding to the document height position type of the document element is for indicating an offset between a coordinate of the document element in a document height direction and a second preset reference coordinate.

19. A training apparatus for a document processing model, comprising:
at least one processor; and
a memory connected with the at least one processor in a communication way; wherein,
the memory stores instructions executable by the at least one processor which, when executed by the at least one processor, enable the at least one processor to:
acquire a first sample document;
determine element features of a plurality of document elements in the first sample document and positions corresponding to M position types of each document element according to the first sample document; wherein the document element corresponds to a character or a document area in the first sample document, and M is an integer greater than or equal to 1; and
perform training on a basic model according to the element features of the plurality of document elements and the positions corresponding to the M position types of each document element to obtain the document processing model.

20. A non-transitory computer-readable storage medium storing computer instructions, wherein the computer instructions are used for causing a computer to:
acquire a first sample document;
determine element features of a plurality of document elements in the first sample document and positions corresponding to M position types of each document element according to the first sample document; wherein the document element corresponds to a character or a document area in the first sample document, and M is an integer greater than or equal to 1; and
perform training on a basic model according to the element features of the plurality of document elements and the positions corresponding to the M position types of each document element to obtain the document processing model.
